(19) United States
(12) Patent Application Publication
(10) Pub. No.: US 2004/0073491 A1
(43) Pub. Date: Apr. 15, 2004

(54) Off-line buying authentication system and method

(76) Inventor: Kun Suh, Seoul (KR)

Correspondence Address: Marshall Gerstein & Borun, 6300 Sears Tower, 233 South Wacker Drive, Chicago, IL, 60606-6357, US

(21) Appl. No.: 10/297,077

(22) PCT Filed: May 25, 2001
(86) PCT No.: PCT/KR01/00876

(30) Foreign Application Priority Data
May 27, 2000 (KR) 2000-28889

(51) Int. Cl. G06F 17/60

(52) U.S. Cl. 705/26

(57) ABSTRACT

Disclosed is an off-line buying authentication system and method. Product identification numbers of the off-line selling products are generated to the products and a database for storing the product identification numbers is built. When a consumer buys a product in the off-line manner, accesses the system via a network and inputs a product identification number attached to the product to the system, the system authenticates the product corresponding to the input product identification number as that purchased by the consumer in the off-line manner in the case the product identification number has been registered to the database. After the buying authentication, the system provides the consumer with mileage points or free gifts to be used in further transactions. Accordingly, the consumer can receive the buying authentication services at any time, the mileage points or the free gifts promote the consumer's continuous purchase, and transactions are further activated.

### BACKGROUND OF THE INVENTION

(a) Field of the Invention

The present invention relates to an off-line buying authentication system and method thereof. More specifically, the present invention relates to an off-line buying authentication system and method thereof for checking and authenticating off-line purchases and providing consumers with bonuses, that is, purchase compensations such as mileage points or free gifts.

(b) Description of the Related Art

As the Internet has greatly been popularized, electronic commerce (EC) on the Internet has also been developed for global peoples. EC includes all kinds of transactions using electronic media, techniques and methods under integrated and automated information systems and environments of business-to-business, business-to-peer, peer-to-peer and government-to-business categories, and further includes marketing to clients, advertisements, supply, services, production, transfers, and purchasing.

To activate EC, a mileage point method for providing predetermined bonus points for each transaction so that buyers may obtain price discounts according to the bonuses for subsequent transactions is applied.

Since it is complicated and troublesome to check mileage points earned through off-line transactions, the mileage-point providing service is mainly applied to on-line transactions.

To check conventional off-line transactions, a buyer buys a snack or a tuna can, for example, cuts a portion of an envelope of the snack or a lid of the tuna can and sends it by mail so that the maker may check the buyer's purchase action. However, since this method annoys the buyer because of its long checking process and the buyer cannot instantly receive a response on the request of checking the purchase, many buyers cannot use this method and in particular, the buyers' purchase activities are not continued.

Another method is to issue a member card, in the case of an oil refining company, install a purchase checking system at each gas station, check the buyers' purchase actions and provide them with mileage points. However, this method requires a huge fund for building the system, and accordingly, it is close to impossible for small retail stores to promote sale performances in this way.

### SUMMARY OF THE INVENTION

It is an object of the present invention to easily check off-line transactions, provide purchase compensations such as mileage points or free gifts, and promote buyers' interest.

In one aspect of the present invention, an off-line buying authentication system comprises: an issue information database for storing product identifications (PIDs) for respective products sold off line; a purchase authenticator for authenticating that a product corresponding to a PID is bought off line when the PID input via an input terminal connected via a network is found to be stored in the issue information database; a mileage point processor for providing mileage points to a buyer when a purchase of a product corresponding to a previously input PID is authenticated; a mileage point database for storing the mileage points provided by the mileage point processor according to a buyer's classification code; and a PID register unit for encrypting feature information for each product sold off line, generating the PID, and updating the issue information database according to the PID.

In another aspect of the present invention, In a buying authentication method of an off-line buying authentication system including a database for storing product identifications (PIDs) for respective products sold off line, the method comprises: determining, when a PID is input by an input terminal connected via a network, whether the PID is stored in the database; authenticating, when the PID is stored in the database, that a product corresponding to the PID is bought off line by a buyer; and providing mileage points to the buyer when the buyer is authenticated to have bought the product corresponding to the PID off line.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1(a) shows a concept of an off-line buying authentication according to a preferred embodiment of the present invention;

FIG. 1(b) shows a concept of an off-line buying authentication system and method;

FIG. 2 shows a block diagram of an off-line buying authentication system and method according to a preferred embodiment of the present invention;

FIG. 3 shows a flowchart for generating a product identification number for checking the purchase of products by the off-line buying authentication system according to a preferred embodiment of the present invention;

FIG. 4 shows a flowchart of a buying authentication process executed by the off-line buying authentication system according to a preferred embodiment of the present invention; and

FIG. 5 shows a flowchart for compensating for mileage points executed by the off-line buying authentication system according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

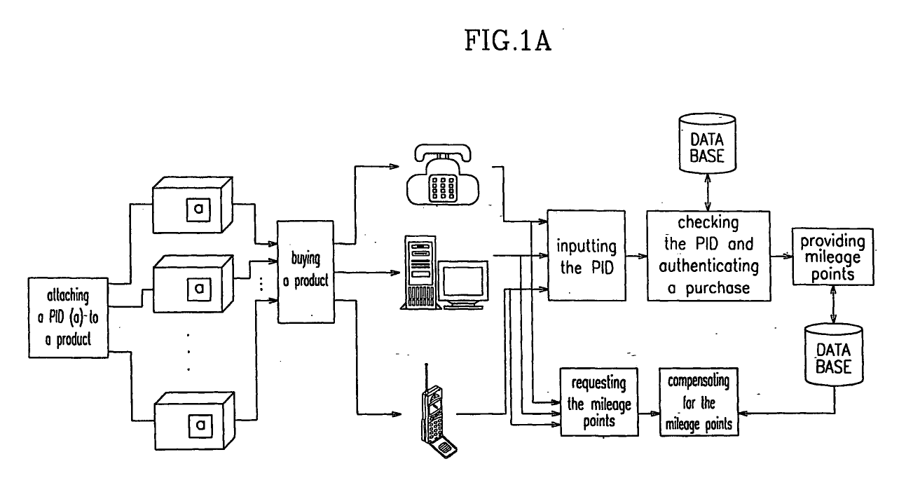

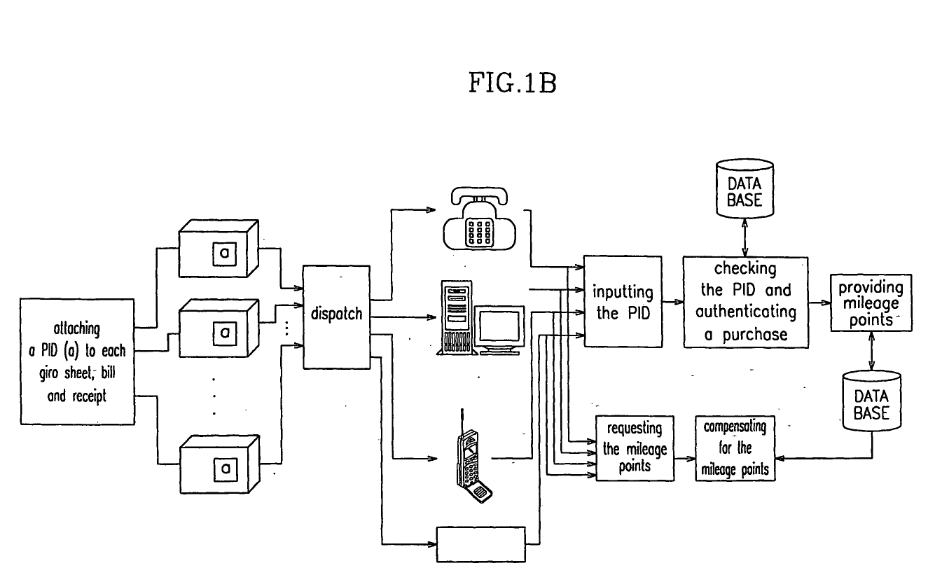

FIG. 1(a) shows a concept of an off-line buying authentication system and method according to a preferred embodiment of the present invention.

As shown, the off-line buying authentication system attaches a product identification PID (a) to a product to be sold off line to check its purchase state, and registers the PID to a database in preparation for subsequent processes of a buyer's purchase-checking and authentication.

When the buyer buys a desired product, accesses the off-line buying authentication system via a network (e.g., a telephone network, a wireless communication network, the Internet or a bank network) and inputs a PID corresponding to the product, the off-line buying authentication system determines whether the currently input PID is matched with the PID stored in the database, and only when they are found to be matched does the off-line buying authentication system authenticate that the buyer has bought the corresponding product off line and provides predetermined mileage points to the buyer to use for subsequent on-line transactions.

FIG. 1(b) shows a concept of an off-line buying authentication system and method using a giro sheet, a bill or a receipt for paying for the product or service according to a preferred embodiment of the present invention.

As shown, the off-line buying authentication system issues the giro sheet, the bill or the receipt with a PID (a) attached to it and registers the issued PID with an additional database. After receiving the giro sheet, the bill or the receipt by mail or in person, the buyer accesses the off-line buying authentication system via the network (e.g., the telephone network, the wireless network or the Internet) and inputs the PID, or the buyer transmits the PID via the network at a bank, and it is determined whether the transmitted PID is matched with the PID stored in the database. When they are found to be matched, the off-line buying authentication system authenticates that the buyer has bought the corresponding product, and provides the buyer with mileage points, a lottery or a free gift to use on-line or off-line.

Next, a configuration and an operation of the off-line buying authentication system will be described in detail.

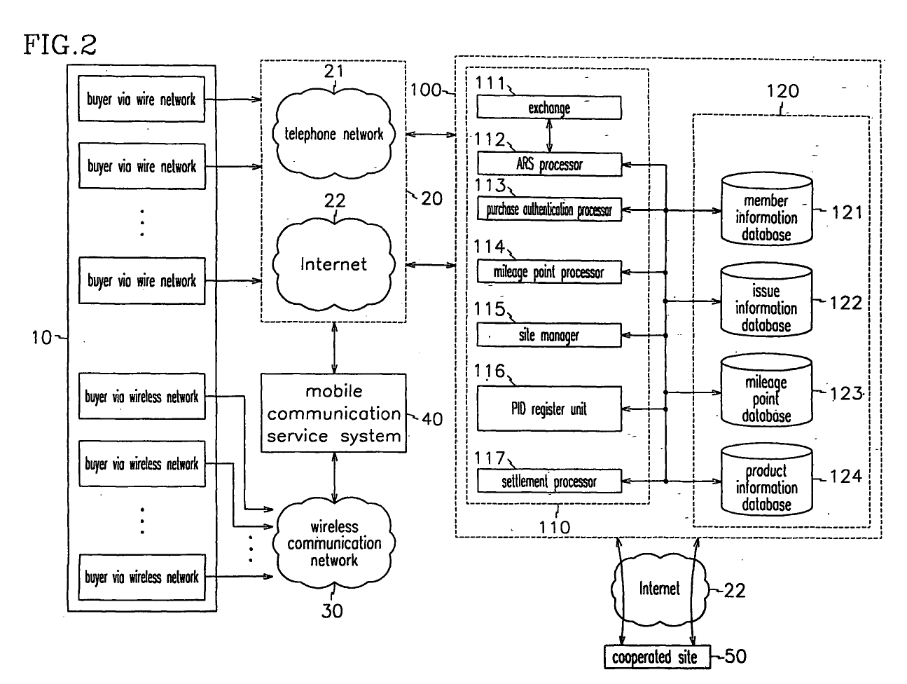

FIG. 2 shows the configuration of the off-line buying authentication system.

As shown, the off-line buying authentication system 100 is connected to an input terminal 10 via a wire network 20 and a wireless communication network (or a wireless network) 30. Here, the wire network 20 includes a telephone network 21 and the Internet 22, and a mobile communication service system 40 is connected between the input terminal 10 and the Internet 22 so that the input terminal 10 may be connected to the off-line buying authentication system 100 via the wireless communication network 30. Also, the off-line buying authentication system 100 is connected via the Internet 22 to a plurality of cooperated sites 50 that share mileage points.

Communication devices for accessing the off-line buying authentication system 100 via the wire or wireless network 20 or 30 such as a wire telephone, a mobile communication terminal, a computer, a bank's terminal, a shopping center's terminal and an Internet television are used as the input terminal 10. Therefore, the buyer can conveniently and quickly access the off-line buying authentication system 100 using the communication device.

As shown in FIG. 2, the off-line buying authentication system 100 comprises a processing server 110 and a database server 120. The database server 120 stores information needed for off-line buying authentications and corresponding provision of mileage points, and the processing server 110 authenticates the buyer's off-line purchase according to the information stored in the database server 120 and provides the mileage points to the buyer according to an authentication result.

In detail, the database server 120 comprises a member information database 121, an issue information database 122 and a mileage point database 123, and can further comprise a product information database 124.

The member information database 121 stores information on the buyers registered as members for checking the off-line purchase and receiving the mileage points for each buyer, such as a corresponding buyer's name, an identification (ID) for a log-in process, a password for a log-in process, an electronic mail address, a local address, a mobile phone number, a wire telephone number, a residence registration number, a password for telephone access, and a credit card number for each member classification code assigned to the buyer.

The issue information database 122 stores PID information generated for each product sold off line to check an off-line purchase, such as a product name, a price, mileage points, a PID issuance date, a PID validity period, and a product maker name for each product code assigned to each product. Here, the product represents any general goods and formless services that can be sold.

The mileage point database 123 stores total accumulated mileage points, used mileage points, available mileage points, a mileage point use period, and the authenticated product's PID for each member classification code of the buyer registered as a member.

The product information database 124 stores information on all products that the buyer can buy using the mileage points provided according to the, off-line buying authentication, such as product names, prices, maker titles, manufacturing dates, and product features according to product codes assigned to the respective products.

The processing server 110 provides the off-line buying authentication and mileage point providing services based on the information stored in the databases 121 to 124, and comprises an exchange 111, an automatic response service (ARS) processor 112, a purchase authentication processor 113, a mileage point processor 114, a site manager 115, a PID register unit 116 and a settlement processor 117.

The exchange 111 performs an interface function between the ARS processor 112 and the input terminal 10 connected via the wire network 20, in particular, the telephone network 21. The ARS processor 112 receives a residence registration number or a password from the input terminal 10 (e.g., a wire telephone) connected via the telephone network 21, performs a member authentication process, and provides the PID input according to a purchase authentication request to the purchase authentication processor 113 to authenticate the purchase, and then provides a processing result executed by the purchase authentication processor 113 to the input terminal 10.

The site manager 115 performs an interface with the input terminal 10 connected via the wireless communication network 30 or the Internet 22, and in particular, the site manager 115 processes member registrations and the members' log-ins that enable the off-line buying authentication and the service of providing the mileage points.

The purchase authentication processor 113 receives the PID from the input terminal 10 confirmed as a member by the site manager 115 or the ARS processor 112, compares the PID with information stored in the issue information database 122, analyzes it, checks whether the PID is valid, and authenticates the purchase of the product bought off line by the buyer according to a checking result.

The mileage point processor 114 provides the mileage points to the buyer whose purchase is authenticated by the purchase authentication processor 113, and in particular, the mileage point processor 114 provides the corresponding buyer with the mileage points previously set for each PID. The mileage point processor 114 increases the accumulated mileage points corresponding to the buyer's member classification code according to the mileage points established for the purchase-authenticated product, or decreases the accumulated mileage points by as much as a number of mileage points used when the buyer uses mileage points, and therefore, the mileage point processor 114 updates the information stored in the mileage point database 123 for each occurrence of purchase authentication or mileage point use.

The PID register unit 116 generates the PIDs for the respective products sold off line, matches the products with the respective PIDs and stores the PIDs in the issue information database 122. In particular, the PID register unit 116 encrypts the PIDs to prevent the buyer from being falsely authenticated by malicious third persons.

When a buyer connected via the wire or wireless network 20 or 30 buys a product registered to the product information database 124, the settlement processor 117 performs a corresponding settlement operation, and in particular, when the buyer requests use of the accumulated mileage points, the settlement processor 117 reduces a predetermined portion of the settlement price by as much as the mileage-points used. In addition, the settlement processor 117 can settle for the products sold on the cooperated site 50.

In this instance, the components 111 to 117 are provided to be operated in the processing server 110, but without being restricted to this, the components can be implemented as independent servers to process corresponding functions.

An operation of the off-line buying authentication system according to the preferred embodiment of the present invention will now be described.

Initially, individual PIDs for the respective products sold off line are issued.

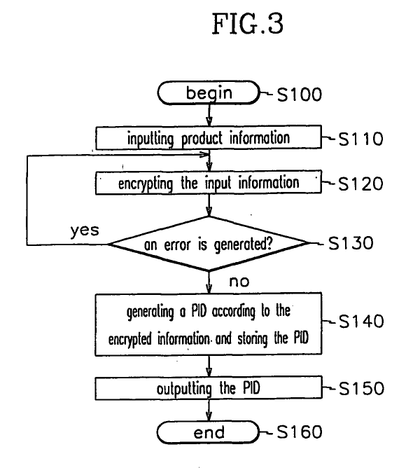

FIG. 3 shows a flowchart of issuing the PID according to the preferred embodiment of the present invention. As shown, when information for generating the PID, such as a product name, a PID issuance date, a PID use period and mileage points is input via an input unit (not illustrated) in steps S100 and S110, the PID register unit 116 encrypts the information so it cannot be stolen in step S120.

When no error is generated during the encryption, the encrypted information is set to be a PID for authenticating the purchase of corresponding products, and the PID is matched with the corresponding product's product code and stored in the issue information database 122 in steps S130 and S140. When errors are generated during the encryption, the information is re-encrypted.

The generated PID is output via an output unit (not illustrated) and printed on a giro sheet, a bill, a receipt, sticking label paper, a package or a letter paper in step S150.

A method for encrypting the product information, that is, a method for generating the PID will now be described.

For example, first and second passwords for encryption are established, a product number, a company classification number and a product serial number (according to the product's manufacturing date) are provided, an output number is generated using the two passwords and these numbers, and the generated output number and the numbers are combined to generate a PID.

That is, the numbers of all digits of the product serial number are added, the second password is multiplied by the added value, and the multiplied value is divided by the first password. The remaining two digits of the obtained divided value are used as the last two digits of an output number, a sum of the last three digits of the product number and the second password are added, and the last digit of the added value is used as the first single digit of the output number.

For example, if the passwords are respectively 117 and 23, the company classification number is 123, the product number is 45 and the product serial number is 49456789, the output number according to the encryption is 795, and the corresponding generated PID is ‘123-45-493456789-795.’

As described, when the PIDs are individually provided to the respective products to be sold off line, the generated PID is printed on the product's package or the product itself, and the PID is coated with aluminum foil so that the buyer may check the PID by scratching the aluminum foil, or the PID is printed on a label paper or a sticker and attached to the product, and accordingly, the buyer can check the PID when buying the product. Also, the PID can be printed on the letter paper to be inserted into the package without attaching it to the product or directly inserting it into the product.

The off-line buying authentication system 100 receives member registration requests from a plurality of buyers who desire to receive services for authenticating the off-line purchase and providing mileage points. The member registration requests are performed via the Internet 22 using a computer or a mobile communication terminal, via the telephone network 21, or by mail. The site manager 115 assigns the member classification codes to each buyer who requested the member registration, receives buyer information such as an ID and a password from the buyer, and stores them in the member information database 121.

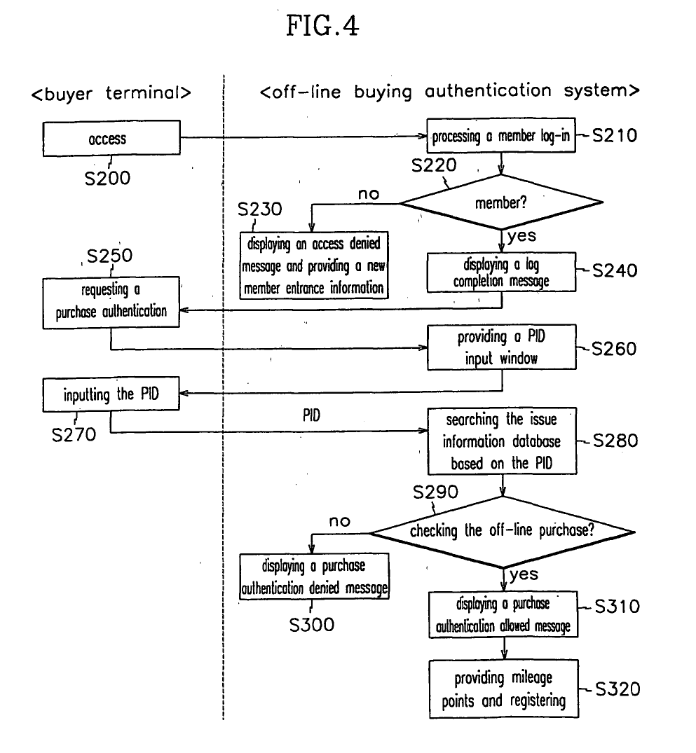

Referring to FIG. 4, described will be a process where a buyer registered as a member of the off-line buying authentication system makes a purchase off line and the buyer's purchase is authenticated via the Internet 22.

When the buyer who made a purchase off line drives a web browser for accessing the Internet 22 on the input terminal 10 and inputs a uniform resource location (URL) to access the site of the off-line buying authentication system 100, the URL information is converted into packets by the hypertext transfer protocol (HTTP) and transmitted to the off-line buying authentication system 100 via the Internet 22. Accordingly, the site manager 115 transmits the homepage corresponding to the URL information to the input terminal 10, and the transmitted homepage is converted into a Windows format and displayed on the web browser at the input terminal 10.

When the input terminal 10 is connected to the off-line buying authentication system 100 via the wireless communication network 30, the URL information of the off-line buying authentication system 100 is converted into the wireless markup language (WML) format via the wireless application protocol (WAP) gateway and transmitted to the mobile communication service system 40 via the wireless communication network 30, and the mobile communication service system 40 connects the input terminal 10 to the off-line buying authentication system 100 according to the URL information.

Accordingly, the buyer checks the information, such as a purchase confirmation menu and a mileage point request menu, provided by the offline buying authentication system 100 via the homepage displayed on the screen of the input terminal 10 in step S200.

When the buyer selects the purchase confirmation menu so as to obtain a purchase authentication on the product bought off line by the buyer, the site manager 115 provides an ID and password input window for checking the buyer's membership, and when an ID and a password are input from the input terminal 10, the site manager 115 checks whether the ID and the password are registered in the member information database 121 in steps S210 and S220.

When they are not registered, the site manager 115 transmits an error message such as ‘access denied’ to the input terminal 10. In this instance, the site manager 115 can provide new member entrance information to the input terminal 10 so as to make the buyer who is not registered as a member be registered in step S230.

When they are registered, the site manager 115 transmits a log-in success message to the input terminal 10 in step S240.

When the buyer selects the purchase confirmation menu and requests a purchase authentication after the above-described member authentication process, in step S250, the purchase authentication processor 113 provides an input window for the buyer to input a PID of the product bought by the buyer in step S260. Accordingly, the buyer inputs the PID attached to the product to the input window in step S270.

When receiving the PID from the input terminal 10, the purchase authentication processor 113 searches the issue information database 122 according to the PID to determine whether the PID input by the buyer is valid in step S280.

When the PID is not stored in the issue information database 122, the purchase authentication processor 113 determines that the purchase of the corresponding product is not executed, and transmits a ‘purchase authentication denied’ message to the input terminal 10 in steps S290 and S300. In this instance, the buyer can re-input the PID to iterate the buying authentication process as described above.

When the PID is stored in the issue information database 122, the purchase authentication processor 113 determines that the buyer made a purchase off line, and transmits a ‘purchase authenticated’ message to the input terminal 10 in step S310. In this instance, information on the buyer's sex, age, occupation, academic background, place of residence and purchase date for each purchase-authenticated product is matched and stored in the product information database 124 so as to obtain information on buying motivation of the corresponding product.

Also, to provide the buyer with various services with respect to the off-line purchase, a free gift application database or a winning result database for effectively managing data is built in order for the purchase-authenticated buyer to apply for free gift events.

The mileage point processor 114 provides the buyer with the mileage points matched with the PID of the issue information database 122, adds the mileage points provided by the purchase authentication to the accumulated mileage points, and transmits data of the total mileage points to the input terminal 10 in order for the buyer to check the same in step S320.

In the above, the purchase by the buyer connected via the Internet is authenticated, and the purchase by the buyer connected via the personal computer (PC) communication is also authenticated using the same method.

When the buyer accesses via the telephone network 21, the ARS processor 112 receives the buyer's residence registration number or password according to the interface of the exchange 111 and performs a member authentication process, and when the buyer is authenticated to be a member, the ARS processor 112 receives the PID from the buyer and provides it to the purchase authentication processor 113 so as to authenticate the purchase of the product. Also, the ARS processor 112 can authenticate the purchase of the buyer who accesses via the telephone network 21.

As described, when the purchase of the product bought off line by the buyer is authenticated and the corresponding mileage points are provided to the buyer according to the purchase authentication, the buyer can subsequently use the accumulated mileage points if necessary.

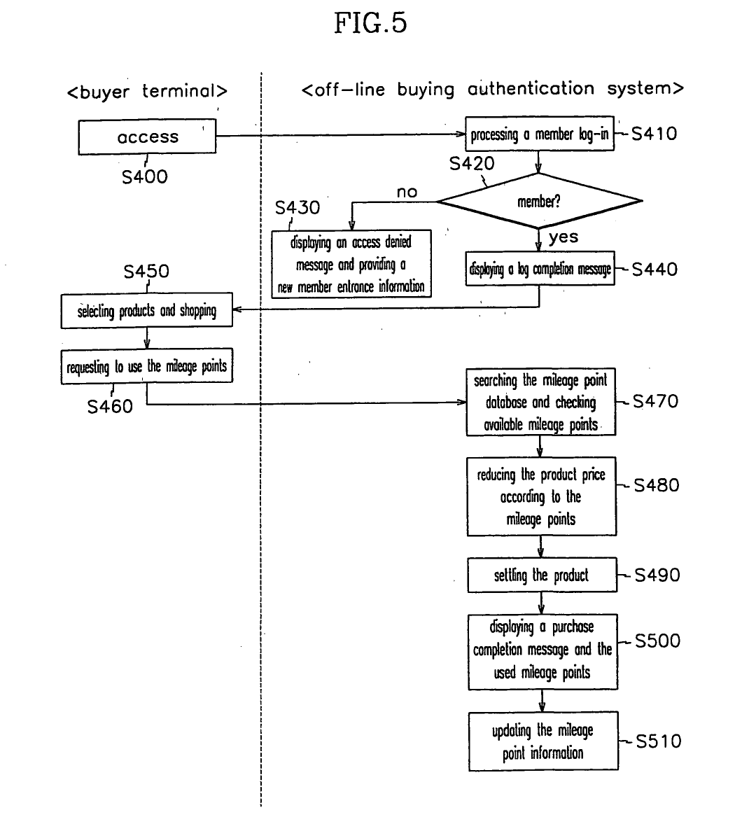

FIG. 5 shows a flowchart for compensating for the mileage points by the off-line buying authentication system according to the preferred embodiment of the present invention.

Identical with the above-described buying authentication process, when the member log-in process by the buyer connected via the Internet 22 is completed in steps S400 to S440, the buyer moves to a product sale page to buy desired products sold by the off-line buying authentication system or other sites 50 cooperated with the off-line buying authentication system on the tasks of product sales or compensations of the mileage points.

When the buyer selects a desired product and requests to use mileage points in steps S450 and S460, the mileage point processor 114 searches the mileage point database 123 and checks the available mileage points in step S470. Accordingly, the buyer's accumulated mileage points are selectively used according to the buyer's selection of using the mileage points.

For example, the mileage point processor 114 displays the total accumulated mileage points to the buyer so that the buyer may check them, and the buyer applies a predetermined portion of the mileage points to the product price in step S480. Hence, the corresponding price is reduced, and if the mileage points of the buyer are greater than the product price, the buyer can buy the product using only the mileage points.

The settlement processor 117 uses the buyer's credit card number to settle the mileage-point-reflected price, and transmits data on the settlement completion and used mileage points to the input terminal 10 in order for the buyer to check the purchase history in step S490.

The mileage point processor 114 updates information stored in the mileage point database 123 according to the buyer's mileage point use history, and manages the buyer's compensated mileage points in steps S500 and S510.

The buyer can use the mileage points provided by the off-line buying authentication system to pay for the mobile communication fee as well as the product price.

As described, the purchase of retail goods can be easily authenticated without building an additional system, and the buyer can obtain the authentication of the purchase of the; products bought off line any time and any where.

Since the purchase of products sold off line is authenticated and corresponding mileage points are provided to the buyer, the buyer's subsequent transactions can be generated. Sales performance via the off-line method in addition to the on-line method is increased, and accordingly, more transactions are activated.

While this invention has been described in connection with what is presently considered to be the most practical and preferred embodiment, it is to be understood that the invention is not limited to the disclosed embodiments, but, on the contrary, is intended to cover various modifications and equivalent, arrangements included within the spirit and scope of the appended claims.

What is claimed is:

1. An off-line buying authentication system comprising:
an issue information database for storing product identifications (PIDs) for respective products sold off line; and
a purchase authenticator for authenticating that a product corresponding to a PID is bought off line when the PID input via an input terminal connected via a network is found to be stored in the Issue information database.

2. The system of claim 1, wherein the system further comprises:
a mileage point processor for providing mileage points to a buyer when a purchase of a product corresponding to a previously input PID is authenticated; and
a mileage point database for storing the mileage points provided by the mileage point processor according to the buyer's classification code.

3. The system of claim 1, wherein the system further comprises:
a PID register unit for encrypting feature information for each product sold off line, generating the PID, and updating the issue information database according to the PID.

4. The system of claim 3, wherein the feature information of a product includes a product name, a use period of the PID, and applied mileage points.

5. The system of claim 1, wherein the network is a telephone network, and the system further comprises an automatic response service (ARS) processor for processing a purchase authentication request of the buyer connected via the telephone network.

6. In a buying authentication method of an off-line buying authentication system including a database for storing product identifications (PIDs) for respective products sold off line, the method comprising:
determining, when a PID is input by an input terminal connected via a network, whether the PID is stored in the database; and
authenticating, when the PID is stored in the database, that a product corresponding to the PID is bought off line by a buyer.

7. The method of claim 6, wherein the method further comprises:
providing mileage points to the buyer when the buyer is authenticated to have bought the product corresponding to the PID off line.

8. The method of claim 7, wherein the mileage points are differently provided to the buyer according to the product.

9. The method of claim 6, wherein the method further comprises:
encrypting feature information for each product sold off line, generating a PID, storing the PID in the database, printing out the PID, and attaching it to or inserting it into the product.

10. A buying authentication method comprising:
issuing an encrypted identification (ID) and building a database for storing the ID so as to authenticate a purchase of a product sold off line;
printing the ID on the product, attaching the ID to it or inserting the ID into it, and selling the product.
performing a purchase authentication based upon the ID when a buyer inputs, via a network, the encrypted ID provided to the product bought off line by the buyer; and
providing mileage points or free gifts to the buyer according to the off-line purchase of product when the purchase is authenticated.

11. A buying authentication method comprising:
issuing an encrypted identification (ID) and building a database for storing the ID so as to authenticate a purchase of a product sold off line;
printing the ID on a device for buying products or paying for services, and providing the ID-printed device when a buyer makes a purchase;
performing a buying authentication based upon the ID when the buyer inputs, via a network, the encrypted ID printed on the device and provided with the product bought off line by the buyer; and
providing mileage points or free gifts to the buyer according to the off-line purchase of the product when the purchase is authenticated.
